(19) United States
(12) Patent Application Publication
(10) Pub. No.: US 2020/0248563 A1
(43) Pub. Date: Aug. 6, 2020

(54) AIRCRAFT ROTOR BLADE INSERT

(71) Applicant: Sikorsky Aircraft Corporation, Strafford, CT (US)

(72) Inventors: Justin Thomas, New Haven, CT (US); Krzysztof Kopanski, Trumbull, CT (US); Mark W. Scott, Bethany, CT (US)

(21) Appl. No.: 15/769,022

(22) PCT Filed: Aug. 18, 2016
(86) PCT No.: PCT/US2016/047552

§ 371 Date: Apr. 17, 2018

Related U.S. Application Data
(60) Provisional application No. 62/243,811, filed on Oct. 20, 2015.

(51) Int. Cl. F01D 5/18; B64C 27/467; B64C 27/473

(52) U.S. Cl. CPC F01D 5/186; F01D 5/188; B64C 27/473; B64C 27/467

(57) ABSTRACT

An inset configured for use in a rotor blade is provided including a body having a shape generally complementary to a hole formed in the rotor blade. An opening extends between a first surface and a second surface of the body. The opening is configured to provide a fluid flow path between an interior and an exterior of the rotor blade.

### STATEMENT REGARDING FEDERALLY SPONSORED RESEARCH OR DEVELOPMENT

This invention was made with Government support under with the United States Government under Contract No. HR0011-14-C-0010 DARPA. The Government has certain rights in this invention.

### BACKGROUND

Exemplary embodiments of the disclosure relate to a rotor system of a rotary wing aircraft, and more particularly, to a rotor blade for such an aircraft.

A conventional rotary-wing aircraft, such as a helicopter, includes a rotor hub configured to rotate about an axis and having multiple rotor-blade assemblies mounted thereto. Each rotor-blade assembly includes a blade that extends outwardly form the rotor hub.

To achieve desirable aerodynamic characteristics, it has been suggested that air within the interior of the rotor blades is pumped through an opening formed in the upper surface of the blade adjacent the leading edge. However, due to the complex geometry of the slot opening needed to achieve desirable aerodynamic properties, formation of the opening in the upper surface is not only difficult, but may also cause the formation of areas of high levels of stress resulting in blade failure.

Accordingly, there is a need for a mechanism that provides the ability to incorporate very complex slot passageways into a rotor blade without needing to manipulate the rotor blade for the manufacture of such small passages. Such a mechanism will drastically reduce the risk of fabrication errors and subsequent loss of a large, expensive rotor blade. Intricate slot passageways have sharp angular features which cause high stress concentration factors. The mechanism described herein is intended to eliminate these features from the blade primary load path which significantly increases blade strength relative to a slot cut into the blade.

### BRIEF DESCRIPTION

According to an embodiment, an inset configured for use in a rotor blade is provided including a body having a shape generally complementary to a hole formed in the rotor blade. An opening extends between a first surface and a second surface of the body. The opening is configured to provide a fluid flow path between an interior and an exterior of the rotor blade.

In addition to one or more of the features described above, or as an alternative, in further embodiments the insert is configured to removably mount within the hole.

In addition to one or more of the features described above, or as an alternative, in further embodiments the body and the opening are configured to achieve desired aerodynamic properties.

In addition to one or more of the features described above, or as an alternative, in further embodiments the insert comprises a material other than a material of the rotor blade.

In addition to one or more of the features described above, or as an alternative, in further embodiments the insert is manufactured using an additive manufacturing technique.

According to another embodiment, a rotor system for use in a rotary wing aircraft having a rotor hub is provided including at least one rotor blade mounted to the rotor hub. The at least one rotor blade includes a spar having an upper surface with a hole formed therein. An insert removably mounted within the hole includes a body having a shape generally complementary to the hole formed in the spar. Stresses inducted into the spar are not reacted by the insert.

In addition to one or more of the features described above, or as an alternative, in further embodiments the insert is bonded within the hole.

In addition to one or more of the features described above, or as an alternative, in further embodiments the insert is press fit within the hole.

In addition to one or more of the features described above, or as an alternative, in further embodiments a first surface of the insert is substantially flush with the upper surface of the rotor blade.

In addition to one or more of the features described above, or as an alternative, in further embodiments the body further comprises an opening extending between a first surface and a second surface of the body. The opening is configured to provide a fluid flowpath between an interior of the spar and an exterior of the rotor blade.

In addition to one or more of the features described above, or as an alternative, in further embodiments a structural ring is disposed in the hole. The tresses in the spare are reacted by the structural ring to isolate the insert from the structural stresses experienced by the rotor blade.

In addition to one or more of the features described above, or as an alternative, in further embodiments an aircraft is provided including the rotor system.

According to another embodiment, a method of changing an aerodynamic property of a rotor blade including a spar having an upper surface with a hole formed therein is provided including removing an insert mounted within the hole to create an empty hole in the spar. The insert includes a first body having a shape generally complementary to the hole formed in the spar of the rotor b lade. Another insert is installed into the empty hole. The another insert has a second body having a same shape relative to the hole as the first body.

In addition to one or more of the features described above, or as an alternative, in further embodiments the second body includes an opening extending between a first surface and a second surface of the body. Inserting the another insert includes providing a fluid flowpath between an interior of the spar and an exterior of the rotor blade via the opening.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of an exemplary rotary wing aircraft;

FIG. 2 is a plan form view of a rotor blade of a rotary wing aircraft according to an embodiment;

FIG. 3 is a perspective view of a rotor blade of a rotary wing aircraft according to an embodiment;

FIGS. 4a-4d are various views of an insert configured for use with a rotor blade according to an embodiment; and

FIG. 5 is a cross-sectional view of a rotor blade including an insert according to an embodiment.

The detailed description explains embodiments of the invention, together with advantages and features, by way of example with reference to the drawings.

### DETAILED DESCRIPTION OF THE INVENTION

Referring now to the FIGS., a non-limiting example of a rotary-wing aircraft is generally illustrated at 10. Although the aircraft 10 illustrated and described herein is a helicopter, it is understood that the aircraft 10 can be any suitable type of aircraft or machine. For example, a high-speed compound rotary-wing aircraft with supplemental translational-thrust systems, a dual contra-rotating coaxial rotor-system aircraft, turboprops, tilt-rotors, and a tilt wing aircraft are also within the scope of the disclosure. Furthermore, although the disclosure is implemented herein with main rotor blades or tail rotor blades having “retreating side blowing” technology (hereinafter “RSB”), it is understood any suitable technology that requires openings in a blade, such as those used for weight cups for holding weights to balance rotor blades for example, are also within the scope of the disclosure. In addition, it is understood that the disclosure may be implemented on any other airfoil-type blade, such as a stationary or wind vane, wind-turbine blade, or propeller blade on a fixed wing aircraft.

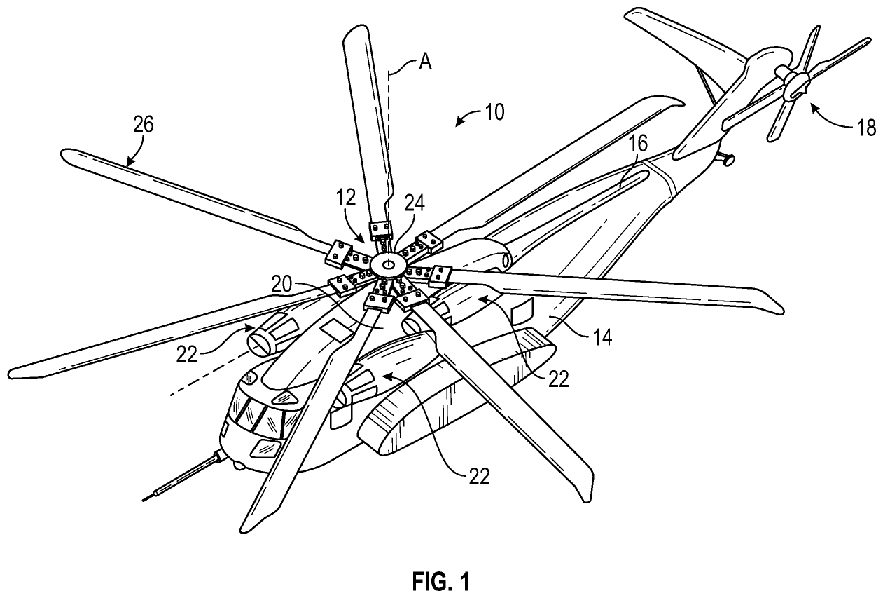

Referring now to FIG. 1, the aircraft 10 includes a main rotor system 12 and an airframe 14 having an extending tail 16 that mounts a tail-rotor system 18 as an anti-torque system. The main rotor system 12 is driven about an axis of rotation A through a main gearbox 20 by at least one engine 22 (three shown in the FIG.). The main rotor system 12 also includes a rotor hub 24 having a plurality of rotor blades, generally indicated at 26, mounted to and projecting radially outwardly from the rotor hub 24. In one embodiment, the blades 26 are made of a composite material, such as a carbon-fiber composite for example. It is understood that the aircraft can have any suitable configuration. It is also understood that the contour and cross-section (in size and shape) of the blade 26 may vary of the length of the blade 26. It is also understood that the blade 26 may be formed using known design and manufacturing processes.

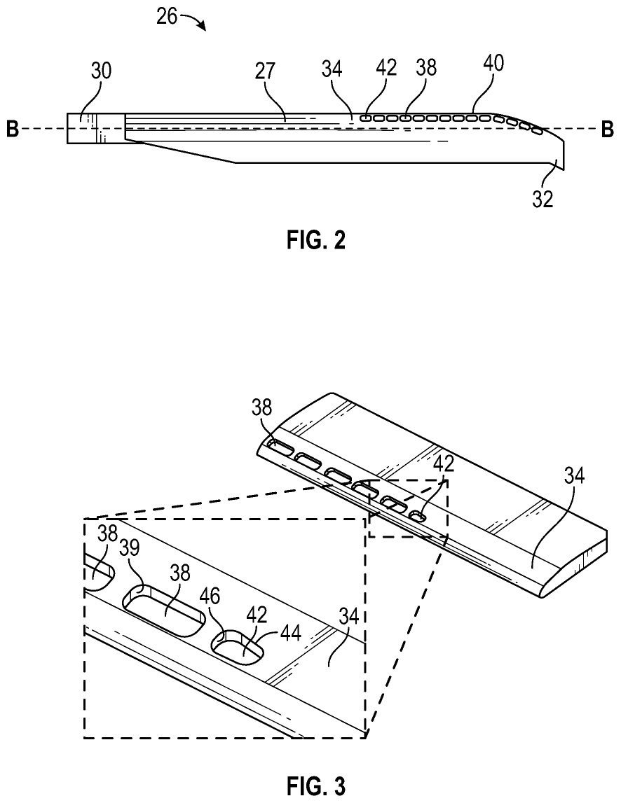

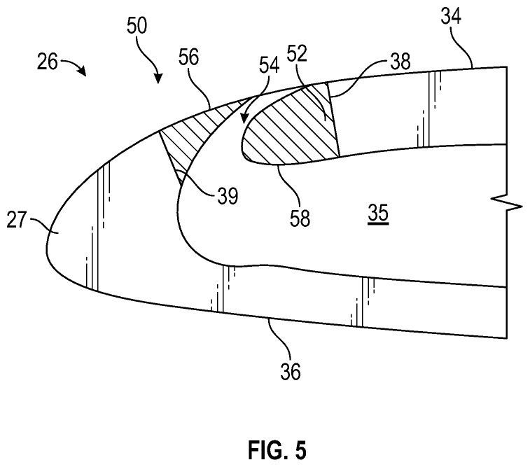

With reference now to FIG. 2, each blade 26 is configured to couple to the rotor hub 24 at an inboard end 30 of the blade 26 disposed opposite a tip 32 of the blade 26. The loads from the blade 26 are reacted using a spar 27 located at the leading edge 40 as shown in FIG. 5. It is understood that the inboard end 30 and tip 32 can define any suitable geometry. Blade axis B is defined longitudinally between the inboard end 30 and the tip 32 of the blade 26. The blade 26 defines an upper surface 34 and an opposite lower surface 36 (best shown in FIG. 5). The upper surface 34 of the blade 26 includes at least one hole 38. The at least one hole 38 may be positioned adjacent a leading edge 40 of the upper surface 34 such that part of the upper surface 34 is arranged between the hole 38 and the leading edge 40 of the blade 26 as shown in detail in FIG. 3. The blade 26 is a composite blade, however it is understood that aspects of the invention can be implemented in non-composite blades such as blades made with metal.

In the illustrated, non-limiting embodiment, the upper surface 34 includes a plurality of holes 38 spaced apart from one another in a radial direction with respect to the hub 24 along each blade 26. The plurality of holes 38 may be substantially identical (i.e. same size and shape) with respect to each other such that each of the plurality of holes 38 is arranged parallel to the leading edge 40 of the blade 26. In addition, spacing between adjacent holes 38 may be uniform and no greater than the chordal length of an end of any hole 38. In the embodiment illustrated in the FIGS., the length of the spacing is substantially shorter than such chordal length.

Each hole 38 can be of any suitable shape and size, which generally depends on the properties of the material of which the upper surface 34 is made. For example, each hole 38 can be shaped as a racetrack having arcuate ends and substantially linear sides. It should be understood that each hole 38 can have any suitable relationship with the remainder of the plurality of holes 38, the upper surface 34, and the remainder of the blade 26. In addition, the plurality of holes 38 can consist of any suitable number of holes 38, define any suitable length, and have any suitable relationship with the upper surface 34 and remainder of the blade 26. Spacing between corresponding adjacent holes 38 can be non-uniform and of any suitable distance.

Although not required, the illustrated, non-limiting embodiment of the blade illustrated in FIG. 3, includes a leader hole 42 extending entirely or partially through the upper surface 34. The leader hole 42 may be spaced from and adjacent to the one or more holes 38. The leader hole 42 may be configured to gradually increase in size from a first end 44 farthest from the hole 38 to an opposed end 46 of the leader hole 42, proximate the hole 38.

With reference now to FIG. 5, in accordance with an embodiment of the disclosure, each hole 38 of rotor blades 26 include a structural ring 39 disposed on an inner surface of hole 38 to provide reinforcement and to reduce warping of hole 38. Those skilled in the art will readily appreciate that structural ring 39 can be a thin-walled ring made of a variety of suitable materials, such as, titanium, steel, or the like. It is contemplated that it is optional to include structural ring 39 in combination with hole 38, it is also contemplated that structural ring 39 can be used with holes other than holes 38, e.g. race-track shaped holes. Further, where the inner surface of the hole 38 provides sufficient structural strength without the structural ring 39, the structural ring 39 need not be used. Further, it is understood that the structural ring 39 could be made integral to the inner surface 39 of the hole 38 in other aspects.

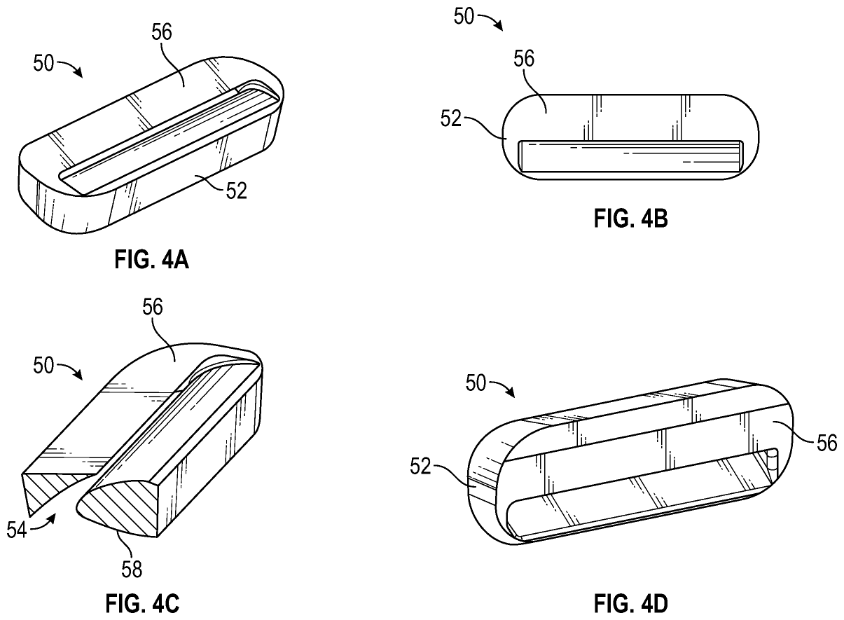

Each of the one or more holes 38 and/or the leader hole 42 may be configured to removably receive an insert 50 therein to form a passage having desirable aerodynamic characteristics through the upper surface 34 of the blade 26. The insert 50 may, but need not be formed from the same material as the blade 26. An example of an insert 50 is illustrated in more detail in FIGS. 4a-4d. As shown, the insert 50 includes a body 52 having arcuate ends and substantially linear sides, similar to the one or more holes 38 of FIG. 3. However, it should be understood that the body 52 may have any shape generally complementary to a hole 38, 42 within which the insert 50 is configured to be received.

As best shown in FIG. 5, the body 52 of the insert 50 includes an opening 54 that extends from a first surface 56 to a second opposite surface 58 of the insert 50 to provide a fluid passageway or outlet for air to escape from a hollow interior portion 35 through the upper surface 34 of the blade 26. Air is pumped through the spar 27, which is hollow, and released to the support surface 34 of the blade 26 through the opening 54. The configuration of the opening 54 is selected to provide desired aerodynamic properties for one or more modes of flight. Although the opening 54 is illustrated as extending at an angle between the first and second surfaces 56, 58, it should be understood that other configurations, such as openings 54 having a vertical, curved, or winding configuration for example, are also within the scope of the disclosure. In addition, the horizontal cross-sectional area of the opening 50, may be uniform, or alternatively may vary between the first surface 56 and the second surface 58 of the insert 50. In the illustrated, non-limiting embodiment, the opening 54 narrows as the air flow approaches the upper surface 34 of the blade 26. Further, the opening 54 may extend over all or only a portion of the length of the insert 50, measured parallel to the leading edge 40 of the blade 26 when installed therein.

In one embodiment, the insert 50 is formed via an additive manufacturing process, which allows for fabrication of an insert 50 having a complex geometry that may not be suitable for use with other conventional manufacturing methods. After the insert 50 is formed, the insert 50 is installed into a corresponding hole 38 or 42 formed in the upper surface 34 of the blade 26. In one embodiment, the insert 50 may be bonded to the interior surface 39 (FIG. 3) of the hole 38 such as via an adhesive or other bonding agent. Alternatively, the insert 50 may be press fit into the hole 38. It should be understood that other mechanisms for mounting the insert 50 within a corresponding hole 38 are also within the scope of the disclosure. When the insert 50 is mounted within the hole 38, the surface 56 of the insert body 52 is arranged substantially flush with the upper surface 34 of the rotor blade 26.

By mounting an insert 50 having a complex geometry within one of the holes of the blade 26, the areas where stress concentrations are most likely to occur are formed within the hole 38, such as at the structural ring 39, such that they remain in the blade 26 itself, and are isolated from the insert 50. Accordingly, the insert 50 is intended to as a modular component that can be easily replaced when damage or failure occurs and need not be designed to accommodate stresses from the rest of the blade 26. Although the insert 50 is retained within the hole 38 or 42 during operation of the aircraft 10, the insert 50 is removable relative to the hole 38 for improved maintenance. By isolating the structure of the insert 50 from the blade 26, the insert 50 can have highly complex shapes which are not achievable otherwise. Further, to the extent the insert 50 is damages instead of the blade 26, the insert 50 can be more easily replaced resulting in a significant decrease in the number of blades 26 being replaced and the costs associated therewith.

While a particular type of insert 50 is shown, it is understood that in other aspects, the insert 50 could have more than one opening 54, or need not have any opening 54 such as where the blade 26 is being used without RSB or where the insert 50 is being used for balancing the blades like a weight cup.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An insert configured for use in hole in a rotor blade, comprising:
a body having a shape generally complementary to a hole formed in the rotor blade; and
an opening extending between a first surface and a second surface of the body, the opening being configured to provide a fluid flowpath between an interior and exterior of the rotor blade when the insert is mounted in the hole.

2. The insert according to claim 1, wherein the insert is configured to removably mount within the hole.

3. The insert according to claim 1, wherein the body and the opening are configured to achieve desired aerodynamic properties.

4. The insert according to claim 1, wherein the insert comprises a material other than a material of the rotor blade.

5. The insert according to claim 1, wherein the insert is manufactured using an additive manufacture technique.

6. A rotor system for use in a rotary wing aircraft having a rotor hub, comprising:
at least one rotor blade mountable to the rotor hub, the blade including a spar and having an upper surface having a hole formed therein; and
an insert removably mounted within the hole, the insert including a body having a shape generally complementary to the hole formed in the spar of the rotor blade; wherein stresses inducted in the spar are not reacted by the insert.

7. The rotor system according to claim 6, wherein the insert is bonded within the hole.

8. The rotor system according to claim 6, wherein the insert is press fit within the hole.

9. The rotor system according to claim 6, wherein a first surface of the insert is substantially flush with the upper surface of the rotor blade.

10. The rotor system according to claim 6, wherein the body further comprises an opening extending between a first surface and a second surface of the body, the opening being configured to provide a fluid flowpath between an interior of the spar and an exterior of the rotor blade.

11. The rotor system according to claim 6, further comprising a structural ring disposed in the hole, wherein the stresses in the spar are reacted by the structural ring to isolate the insert from the structural stresses experienced by the rotor blade.

12. An aircraft comprising the rotor system of claim 6.

13. A method of changing an aerodynamic property of a rotor blade, the blade including a spar and having an upper surface having a hole formed therein, the method comprising:
removing an insert mounted within the hole to create an empty hole in the spar, the insert including: a first body having a shape generally complementary to the hole formed in the spar of the rotor blade; and
inserting another insert into the empty hole, the another insert having a second body having a same shape relative to the hole as the first body.

14. The method of claim 13, wherein the second body further comprises an opening extending between a first surface and a second surface of the body, wherein the inserting further comprises providing a fluid flowpath between an interior of the spar and an exterior of the rotor blade via the opening.
